(19) United States
(12) Patent Application Publication
(10) Pub. No.: US 2012/0291303 A1
(43) Pub. Date: Nov. 22, 2012

(54) HAND DRYER

(75) Inventors: Stephen Benjamin Courtney, Malmesbury (GB); Patrick Joseph William Moloney, Malmesbury (GB); Christopher Lesniowski, Malmesbury (GB)

(73) Assignee: Dyson Technology Limited, Malmesbury (GB)

(21) Appl. No.: 13/474,303

(22) Filed: May 17, 2012

(30) Foreign Application Priority Data
May 17, 2011 (GB) 1108241.9

(51) Int. Cl. F26B 25/06

(52) U.S. Cl. 34/202

(57) ABSTRACT

A hand dryer comprising a plurality of hand dryer nozzles—one or more for each of a user's hands. The left hand dryer nozzle(s) are arranged to extend across the width of the user's left hand when it is held palm-open in front of the left-hand nozzle(s), and the right-hand dryer nozzle(s) are likewise arranged to extend across the width of the user's right hand when it is held palm-open in front of the right-hand nozzle(s). The left-hand nozzle(s) extend axially along the wall of a first air supply duct, and the right hand nozzle(s) similarly extend axially along the wall of a second air supply duct. Each air supply duct communicates at its inlet end—being the end nearer the user's respective thumb in use—with a motor driven-fan for driving an axial airflow through duct.

### REFERENCE TO RELATED APPLICATIONS

This application claims priority of United Kingdom Application No. 1108241.9, filed on 17 May 2011, the entire contents of which are incorporated herein by reference.

### FIELD OF THE INVENTION

The present invention relates generally to the field of hand dryers, and particularly—though not exclusively—to arrangements for hand-drying at a sink such as may be provided in a commercial washroom or the like.

### BACKGROUND OF THE INVENTION

In washrooms, it is common to provide one or more sinks or water basins for washing, and one or more separate, wall-mounted hand-dryers which users can then use to dry their hands.

FIG. 1 illustrates one type of wall-mounted hand-dryer 1, which is currently marketed and sold under the model name AB01, as part of the Dyson Airblade® range of hand dryers. It works by using a motor-driven fan to force air at high pressure through an opposing pair of narrow, slit-like nozzles 2, 3, each less than 1mm wide. This creates two opposing thin sheets, or “blades”, of high velocity air which act to strip water from the front and backs of a user's hands as they are ‘dipped’—palms flat—between the opposing nozzles 2, 3.

The drying air is fed to the nozzle 3 via a respective air duct 3a which connects to the pressure side of a motor-driven fan (not shown) located inside the hand dryer 1. The air duct 3a flattens near the nozzle so that it spans the width of the nozzle 3. Consequently, air is fed from behind the nozzles 3, with different portions of the nozzle 3 effectively being fed in parallel, and the air exits the nozzle 3 “straight-on”. This is illustrated in FIG. 1.

Air is fed to the rear nozzle 2 in a similar manner via a separate duct (not shown) corresponding to the duct 3a. The nozzle 2 is scalloped to follow the back of the user's hands: this deliberate physical shaping of the rear nozzle encourages “turning” of the airflow as it passes through the nozzle 2, so that air is angled both into the thumb and forefinger of the user and also back into the little finger of the user, which improves the overall drying performance. This is also illustrated in FIG. 1.

In some washrooms, hand dryers are instead located over the basin of the sink, so that a user can conveniently dry their hands at the sink—without having to move—and at the same time water dripping from the hands can collect in the basin of the sink and drain into the mains drainage system through the existing waste pipe. One such arrangement is described in U.S. Pat. No. 5,199,118 A.

It is an object of the present invention to seek to provide an improved hand dryer.

### SUMMARY OF THE INVENTION

According to the present invention, there is provided a hand dryer comprising a plurality of hand dryer nozzles—one or more for each of a user's hands, the left hand dryer nozzle(s) being arranged to extend across the width of the user's left hand when it is held palm-open in front of the left-hand nozzle(s), the right-hand dryer nozzle(s) being arranged to extend across the width of the user's right hand when it is held palm-open in front of the right-hand nozzle(s); the left-hand nozzle(s) extending axially along the wall of a first air supply duct, the right hand nozzle(s) extending axially along the wall of a second air supply duct; each air supply duct communicating at its inlet end—being the end nearer the user's respective thumb in use—with a motor driven-fan for driving an axial airflow through duct.

Thus, in accordance with the present invention, air is fed “inside-to-out” axially along the supply ducts. Consequently, the nozzle exit velocity towards the inlet end of the supply ducts has a significant axial component, which tends to angle the airflow into the thumb and forefinger of the user in use, for effective drying of that area of the user's hand. This inherent angling of the airflow into the user's thumb and forefinger is achieved without the additional cost of having to use physically “shaped” nozzles, such as the rear ‘scalloped’ nozzle in FIG. 1: a simple ‘straight-line’ nozzle configuration may instead be used to similar effect.

A large axial component to the nozzle exit velocity may be less preferable away from the user's thumb, where straighter nozzle exit velocities may instead be preferred for providing “square-on” drying of the user's hands. This is addressed by controlling the axial velocity of the airflow along the supply duct so that it decreases along the length of the supply duct, thus progressively “straightening” the nozzle exit velocities.

The axial velocity is controlled using a suitable cross-sectional profile for the supply duct. In one embodiment, the supply duct is arranged to have a generally constant cross-sectional area (preferably cylindrical for ease of manufacture, though this is not essential). In this case, the axial airflow velocity through the supply duct gradually decreases along the duct due to serial airflow losses through the nozzle(s)—in effect, the nozzles are supplied “in series”, not “in parallel” (cf. FIG. 1, in which the duct 3a is effectively a parallel feed duct for the nozzle 3).

The use of a constant cross-sectional area along the supply duct is not essential, however, in order to achieve the aforementioned straightening effect. Alternatively, the cross-sectional area may vary, provided it does so in a manner which nevertheless ensures such straightening of the nozzle exit velocity via a corresponding progressive reduction in the axial flow velocity through the supply duct.

For example, the duct may taper along the length of the supply duct. In this sort of arrangement, serial flow losses through the nozzle(s) will again tend to reduce the axial flow velocity through the supply duct. If the taper is a reverse taper, so that the cross sectional area increases with distance from the inlet end of the duct, then the taper will contribute a further reduction in axial flow velocity along the supply duct, consistent with the Continuity Principle.

By contrast, a forward taper will in accordance with the same Principle tend to increase the axial velocity through the supply duct. In this case, a progressive reduction in the axial nozzle velocity can nevertheless be achieved simply by ensuring that the aforementioned effect of the taper does not entirely off-set the reduction in flow velocity due to serial flow losses through the upstream nozzles (or upstream portions of the nozzle in the case of an elongate slit). Other cross-sectional profiles may likewise be employed whilst nevertheless ensuring a net reduction in axial velocity along the supply duct.

The nozzle(s) preferably extends across the full width of the user's hand, for effective drying across the full hand span of the user.

In one embodiment, the nozzles each span a width in the range of 80 mm to 170 mm, for example.

Though not essential, a preferred range of widths for the nozzle(s) is 130-170 mm (to be measured across all of the nozzles collectively in the case of a plurality of nozzles). This tends to ensure that the nozzle(s) will effectively extend across the majority of user's hands in use. The precise nozzle width will be a trade-off between, on the one hand, a compact fixture design and, on the other hand, the usability of the fixture for users with relatively large hands. Accordingly, the preferred width may vary—for example by country or according to the specific sink design. However, tests show that a width specification of 150 mm for the nozzle(s) (with a tolerance of ±10 mm) generally offers a good compromise in most cases.

The wall of the supply ducts may—and preferably do—form part of the exterior of the hand dryer. This tends to reduce the part count and assembly costs.

The hand dryer will incorporate some sort of airflow generator for forcing air through the nozzles. In particular, the hand dryer may comprise a motor-driven fan which is configured to force airflow through the nozzles at an exit speed which is in the range 50 m/s to 250 m/s, preferably in excess of 100 m/s.

The hand dryer may form part of a “dual-purpose” fixture for a sink, which additionally incorporates a water tap for washing a user's hands. This sort of arrangement allows both washing and drying of the hands to be carried out at the sink.

The water tap may generally incorporate a spout arranged for projecting over the basin of the sink, and the hand dryer may incorporate two hand-dryer nozzles—one for each of a user's hands; wherein the left-hand nozzle is located on the left-hand side of the spout and the right-hand nozzle is located on the right-hand side of the spout so that the spout acts as a dividing partition between the two nozzles.

In this arrangement, the configuration of the fixture means also that the water spout itself is “dual-function”: it both conveys water for washing and then usefully functions as a partition between the hand-dryer nozzles to encourage correct usage of the left-hand nozzle for drying the left hand and the right-hand nozzle simultaneously for drying the right hand.

In this context, the “left-hand side”/“right-hand side” is the side which, in use, is on the user's left/right when the user is standing in front of the sink, facing the fixture. Similarly, the “left hand nozzle”/“right hand nozzle” is the nozzle nominally intended to be used to dry a user's left/right hand.

The fixture may comprise i) an opposing pair of said left-hand nozzles arranged on the left side of the spout for directing air onto the front and back of a user's left hand as it is passed—with open palm—in between the opposing nozzles, and ii) an opposing pair of said right-hand nozzles arranged on the right hand side of the spout for directing air onto the front and back of a user's right hand as it is passed—with open palm—in between the nozzles.

Thus, the nozzles provide an advantageous, “double-sided” hand-drying action. Positioning the opposing nozzles on the fixture—rather than, for example, the opposing walls of the sink—allows the separation between opposing nozzles to be optimized. This is particularly beneficial for high-speed hand dryers (exit airspeed>100 m/s), because subsequent diffusion of the airflow after it exits the nozzles can cause the airspeed to fall off dramatically over distances of the order of a few cm, so the ability to optimize the separation between opposing nozzles is critical to achieving good drying performance.

The left-hand and right-hand nozzles may conveniently be positioned along respective parts of the fixture which extend laterally away from the spout. Equally, said opposing pair of left-hand and right-hand nozzles may conveniently be positioned along respective opposing parts of the fixture which each extend laterally away from the spout. Positioning the nozzles on a laterally-extending part of the fixture—rather than directly on the wall of the spout—allows the nozzles to be located at a more natural width for the user. The laterally-extending parts of the fixture need not extend perpendicular to the spout.

A plurality of left-hand nozzles (or plurality of opposing pairs of left-hand nozzles) may be provided, extending along the respective part (or opposing parts) of the fixture. Similarly, a plurality of right-hand nozzles (or plurality of opposing pairs of right-hand nozzles) may be provided, extending along the respective part (or opposing parts) of the fixture. The nozzles may be arranged in one or more rows on the respective part of the fixture.

Utilizing a plurality of nozzles extending laterally along the respective part of the fixture, the effective width of the drying jet is increased. A similar effect can be achieved using fewer nozzles—possibly one nozzle—if the nozzle(s) is (are) elongated.

The laterally extending parts of the fixture may each comprise the supply ducts.

The nozzles may be fed by an air duct running through the spout. Utilizing the spout for running the air duct to the nozzles provides for a compact fixture design. In this case, the supply ducts would communicate with the motor-driven fan via the air duct running through the spout, and in a particularly simple configuration the supply ducts may effectively be in the form of laterally-extending branches of the air duct running through the spout—so that the supply ducts and main air duct together form a unitary part.

The laterally-extending parts of the fixture and the spout may all lie in a substantially common plane. This helps minimize interference of the fixture with the washing of a user's hands.

In an arrangement comprising the fixture in combination with the sink, the fixture may be fitted to the sink with the spout preferably arranged to project downwardly over the basin of a sink at an angle between 0 and 15 degrees. This makes it particularly comfortable to ‘dip’ the hands—palms open—in front of the nozzles (or between opposing nozzles, as the case may be).

The nozzle(s) may be in the form of an elongate slit, less than 1mm in width, extending along the respective part of the fixture.

### BRIEF DESCRIPTION OF THE DRAWINGS

Embodiments of the invention will now be described by way of example with reference to the accompanying drawings, in which:

FIG. 1 is a perspective view of a conventional hand dryer;

FIG. 2 shows a perspective view of an arrangement comprising a fixture fitted to a sink;

FIG. 3 is a front view of the arrangement in FIG. 2;

FIG. 4 is a section taken along A-A in FIG. 3;

FIG. 5 is a section taken along C-C in FIG. 4;

FIG. 6 is a perspective view—partly enlarged—of part of the fixture shown in FIGS. 2 to 5;

FIG. 7 is a view from the front of the fixture illustrated in FIGS. 2 to 6, illustrating the fixture in use;

FIG. 8 is a plan view corresponding to FIG. 6, but additionally illustrating the nozzle exit velocity profile for one of the supply ducts forming part of the fixture;

FIG. 9 is a schematic view of an alternative, tapering supply duct;

FIG. 10 is a perspective view of an alternative arrangement comprising a fixture fitted to a sink;

FIG. 11 is a perspective view of an alternative arrangement comprising a fixture which is wall-mounted above a sink;

FIG. 12 is a perspective view of an alternative arrangement, illustrating ducting of air along the outside of a spout forming part of the fixture; and

FIG. 13 is a schematic perspective view of an alternative hand dryer according to the present invention.

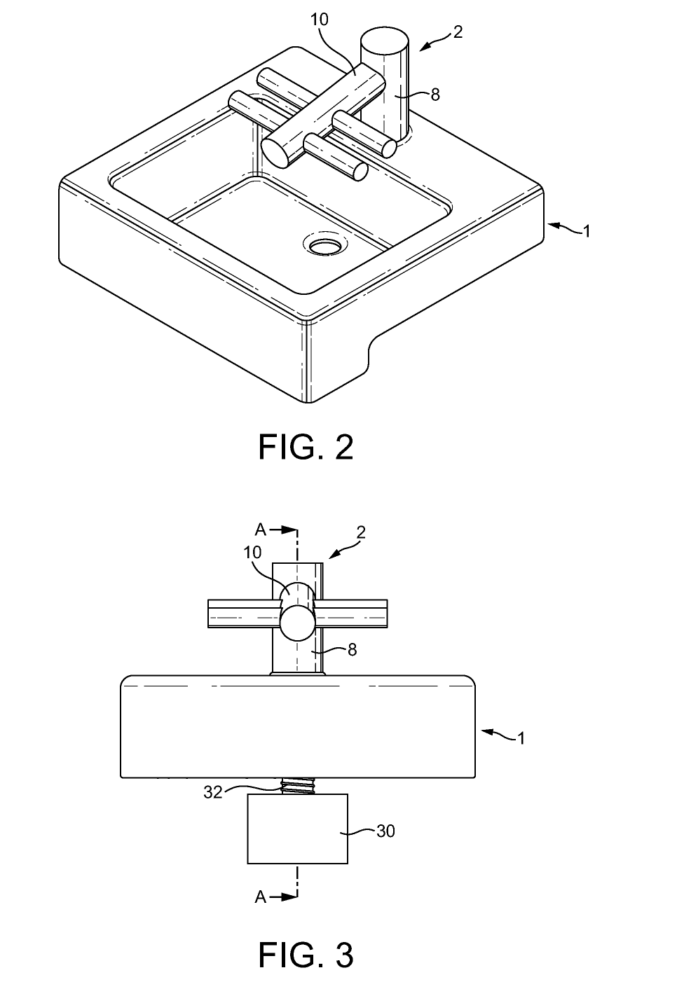

FIGS. 2-5 show various views of an arrangement comprising a conventional sink 1 and a fixture 2.

### DETAILED DESCRIPTION OF THE EMBODIMENTS

The sink 1 happens to be a “Belfast-style” sink, but in general the sink may be of any conventional type.

The fixture 2 is fitted to the sink 1 using a locknut 4 underneath the sink 1 which engages with an externally threaded, hollow fixing stud 6 to clamp the fixture 2 in place (the fixture 2 may alternatively be fitted adjacent the sink rather than to the sink itself, according to the style of sink).

The fixture 2 comprises a water tap having a main body 8 which sits adjacent the basin of the sink 1 and a spout 10 which projects from the main body 8 out over the basin of the sink 1.

On demand, water for washing is supplied from a main supply line via a water supply pipe 12, which runs inside the main body 8 and the spout 10 to a downwardly-facing outlet 10a provided at the fore-end of the spout 10.

The water tap is configured for “hands-free” operation using a conventional sensor and control loop, which automatically opens a stop valve in the supply line in response to detection of a user's hands in a washing position. Alternatively, the water tap may be configured for manual operation.

The fixture 2 also incorporates a hand dryer, which utilizes the inside of the main body 8 and spout 10 as an air duct 11, feeding a plurality of hand-dryer nozzles provided on the fixture 2.

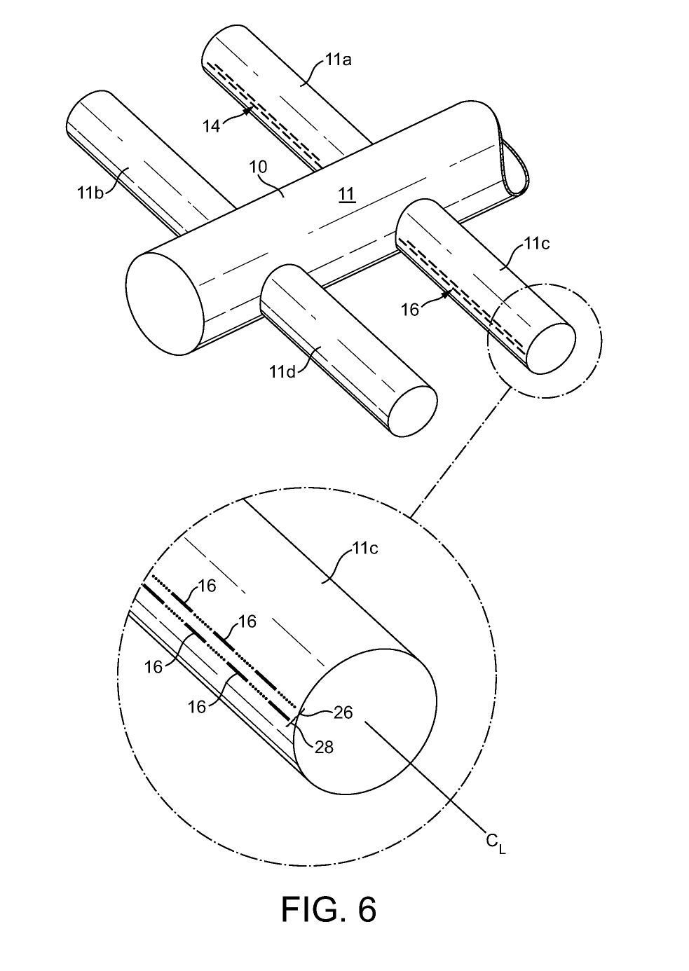

The hand-dryer nozzles are arranged in two groups: a plurality of left-hand drying nozzles 14, which are intended in use for drying the user's left hand, and a plurality of right hand nozzles 16, which are intended in use for drying a user's right hand. The nozzles 14, 16 have been omitted from FIG. 2 for clarity purposes, but are shown in FIG. 6.

The left-hand nozzles 14 are provided on the left-hand side of the spout 10. The right-hand nozzles 16 are provided on the right-hand side of the spout 10.

The left-hand nozzles 14 are arranged in opposing pairs along respective laterally-extending (in this case perpendicularly-extending) supply ducts 11a, 11b, which essentially form integral branches of the air duct 11. Similarly, the right-hand nozzles 16 are arranged in opposing pairs which are positioned along respective laterally-extending (in this case perpendicularly-extending) supply ducts 11c, 11d, which likewise form branches of the air duct 11.

Both the left-hand nozzles 14 and the right hand nozzles 16 take the form of a series of slits cut into the side wall of the relevant supply duct.

The nozzles 14, 16 are arranged in two rows along each respective supply duct 11a-d.

FIG. 6 shows the specific pattern of nozzles 16 on the respective supply duct 11 c, with the nozzles in one row 26 being laterally offset relative to the nozzles in the adjacent row 28. The nozzles 16 on the opposing branch 11 b of the air duct 11 are laterally offset in the opposite sense, indicated by the dotted lines in FIG. 6, so that the pairs of opposing nozzles are not positioned directly opposite one another. This helps to reduce noise in use by preventing collision between the opposing air jets exiting the nozzles 16. The left-hand nozzles 14 are arranged in similar fashion on the respective branches 11a, 11b of the air duct 11.

The air duct 11 is connected to the positive pressure (output) side of a motor-driven fan unit 30 via a flexible hose 32 which fluidly connects to the inside of the main body 8 via the hollow fixing stud 6 (if the water supply pipe 12 runs through the fixing stud 6—effectively within the air supply line—then adequate provision will need to be made to route the pipe 12 to the exterior of the air supply line, for connection to the water supply line). On demand, air is forced by the fan 30 through the air duct 11 and out through each of the nozzles 14, 16.

The hand dryer is configured for “hands-free” operation using a conventional sensor and control loop, which automatically switches on the fan unit 30 in response to detection of a user's hands in a drying position (which should be distinguishable from the aforementioned washing position—which automatically activates the water tap). Alternatively, the hand dryer may be configured for manual operation.

In use, a user can perform both washing and hand-drying operations at the sink 1.

To commence the washing operation, the user places his (or her) hands underneath the outlet 10a as if to wash his hands, and the sensor and control loop operates to deliver water through the outlet 10a. The user can then proceed to wash his hands in conventional manner over the basin of the sink 1.

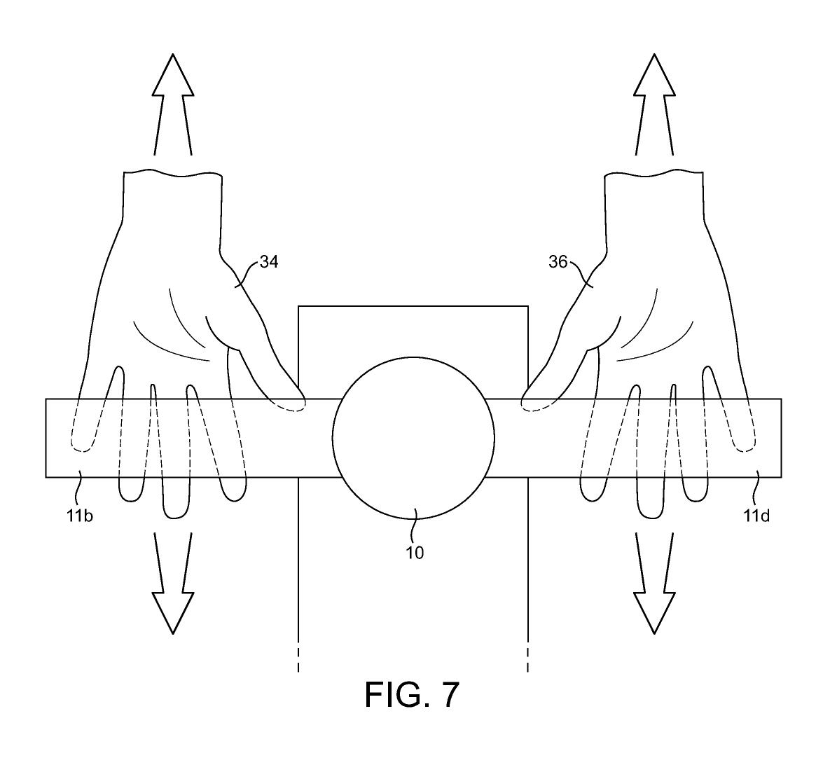

To commence the hand-drying operation, a user dips his wet left-hand—palm open—between the opposing pairs of nozzles 14 on the left-hand side of the spout 10 and, at the same time, dips his wet right-hand—palm open—between the opposing pairs of nozzles 16 on the right hand of the spout 10. The sensor and control loop then operates to activate the fan 30, which forces air under high pressure through the opposing nozzles 14, 16: directing high-momentum airflow onto the front and backs of the user's hands, respectively. To dry his hands, the user then makes one or more generally ‘vertical’ passes between the slots—palms held open—and the high momentum airflow strips water from the surface of the user's hands. The general dipping action of the left hand 34 and right hand 36 is illustrated in FIG. 7 (here, looking axially along the spout 10 from the front), which also illustrates how the spout 10 functions as a central dividing partition between the hands 34, 36, encouraging correct usage.

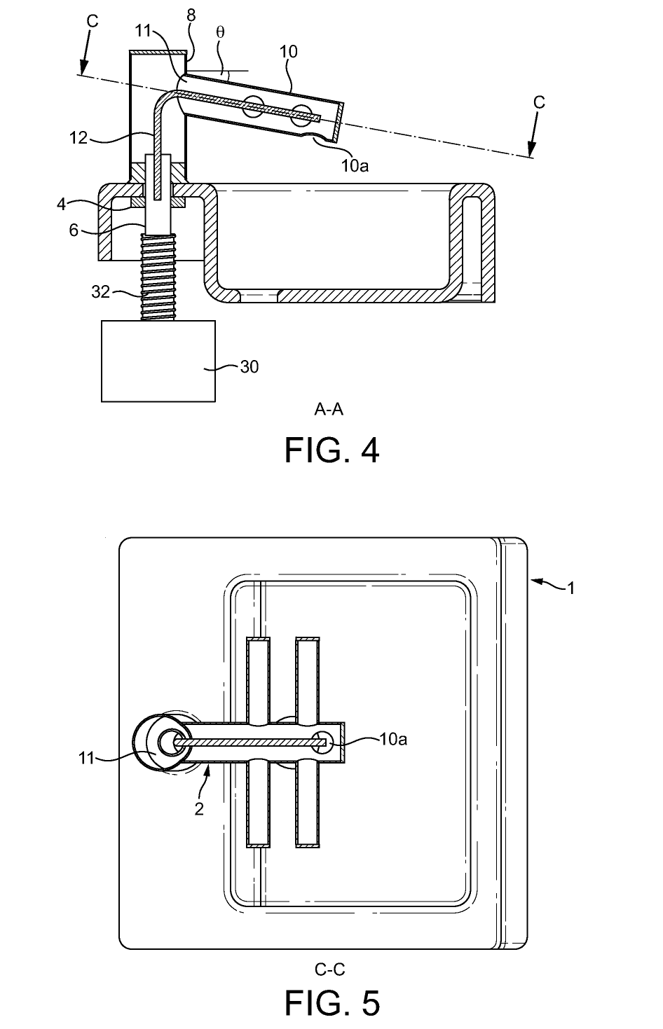

The lateral branch ducts 11a-d lie in generally the same plane as the spout 10, which extends downwardly towards the user at an angle θ (FIG. 4) in the range 5 to 15 degrees, preferably 10 degrees. Thus, rather than the user having to dip his hands vertically between opposing nozzles, the hand entry-angle is tilted towards the user to make the dipping action more comfortable.

The waste water driven from the hands is conveniently collected in the basin of the sink 1, where it may drain to the mains through the conventional plumbing system for the sink 1.

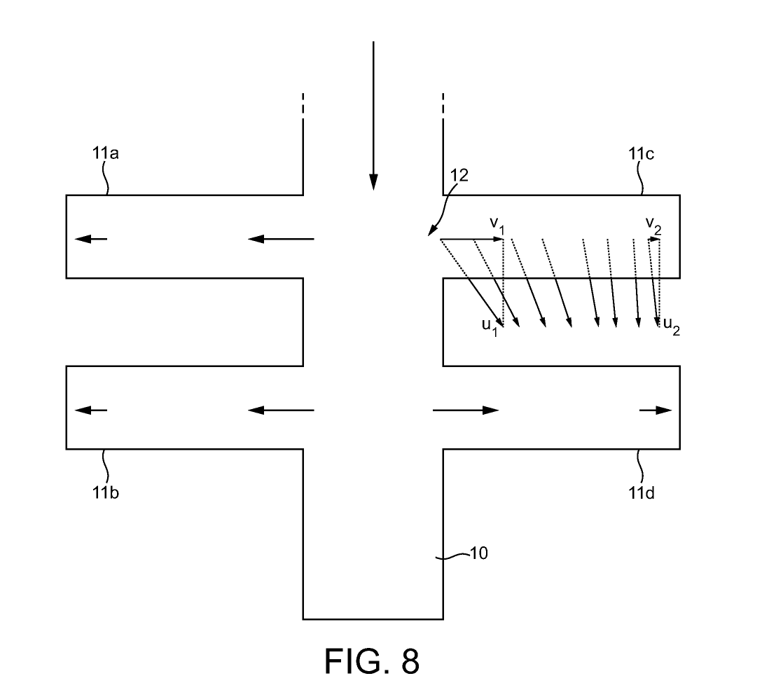

FIG. 8—here, looking down on the fixture 2 from above—shows the nozzle exit velocity profile along the supply duct 11c (which is also illustrative of the exit velocity profile for the remaining supply ducts 11a, 11b, 11d).

The exit velocity profile is characterized by a significant axial component to the nozzle exit velocity U₁ nearer the inlet end 12 of the supply duct 11c, due to the high axial duct velocity V₁. This helps to angle the airflow into the thumb and forefinger for effective drying of this area of the hand.

Away from the inlet end of the branch ducts 11c, there is a progressive decrease in the axial duct velocity due to a combination of serial flow losses through upstream nozzles and the uniform cross-sectional area of the duct 11c. Consequently, there is a progressive straightening of the nozzle exit velocity along the length of the branch ducts (the intermediate nozzle exit velocities are illustrated only schematically in FIG. 8).

So for example, near the very end of the branch ducts 11c, the axial duct velocity V₂ is relatively small and the exit velocity U₂ is relatively straight.

The progressive straightening of exit velocities along the length of the branch ducts 11a-d helps maintain a more neutral “square-on” drying characteristic away from the thumb and forefinger.

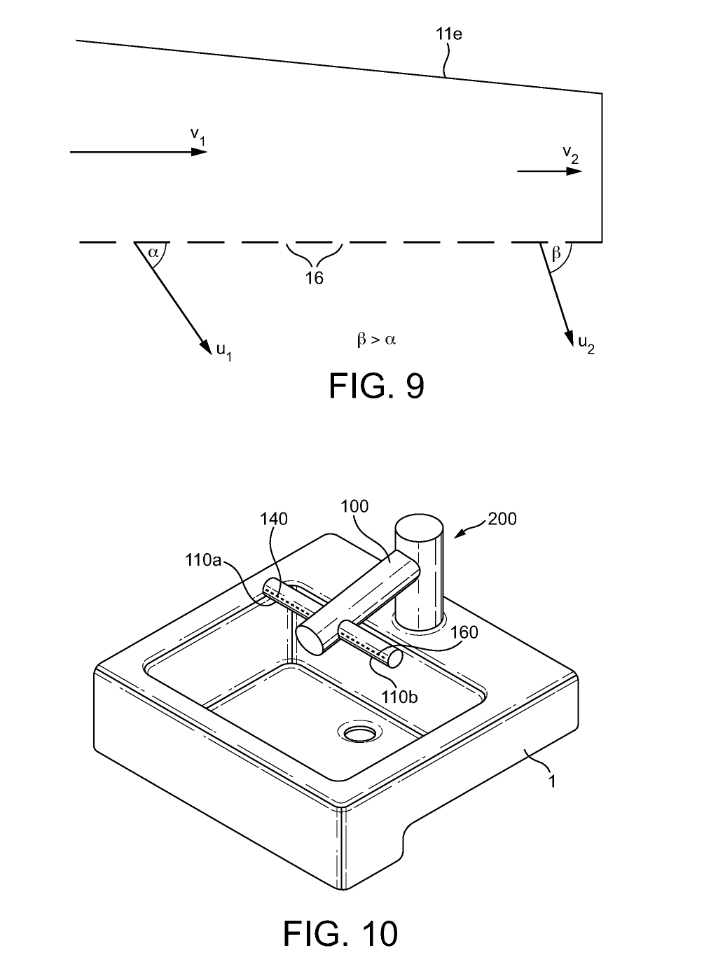

The use of a supply duct having a uniform cross-sectional area is not essential to provide the straightening effect shown in FIG. 8, though use of a cylindrical supply duct may be preferable for ease of manufacture. For example, FIG. 9 illustrates use of a tapered duct, 11e. Here the taper actually off-sets the reduction in axial velocity caused by serial flow losses through the nozzles 16—so the straightening effect is not as pronounced—but a straightening effect is nevertheless achieved by ensuring that the taper angle is sufficiently shallow that there is still a net reduction in axial velocity along the duct: in other words, serial flow losses through the nozzles 16 remain the dominant factor in determining the axial velocity V₂.

The use of opposing pairs of nozzles is not essential. FIG. 10 shows a “single-sided” arrangement in which the fixture 200 has a row of left-hand nozzles 140 on the left-hand side of the spout 100 and a row of right-hand nozzles 160 on the right-hand side of the spout 100. The nozzles 140, 160—which in this case are single rows of circular nozzles—are arranged along respective laterally-extending branch ducts 110a and 110b: one provided for each set of nozzles 140, 160.

The spout 100 projects forward of the two branch ducts 110a and 110b, so as to act as a central dividing partition between the left-hand nozzles 140 and the right-hand nozzles 160. The lateral branch ducts are again arranged in the same plane as the spout 100, which is likewise angled downwardly towards the user at an angle of 10 degrees to provide user comfort during use.

The fundamental hand drying action is similar to the “double-sided” arrangement of FIG. 2: the user dips his left hand—palm open—in front of the left-hand nozzles 140 and at the same time dips his right hand—palm open—in front of the right-hand nozzles 160. However, because the nozzles 140, 160 only direct air onto one side of the user's hands, the user must then flip over his hands and repeat the same process for the reverse side of the hands.

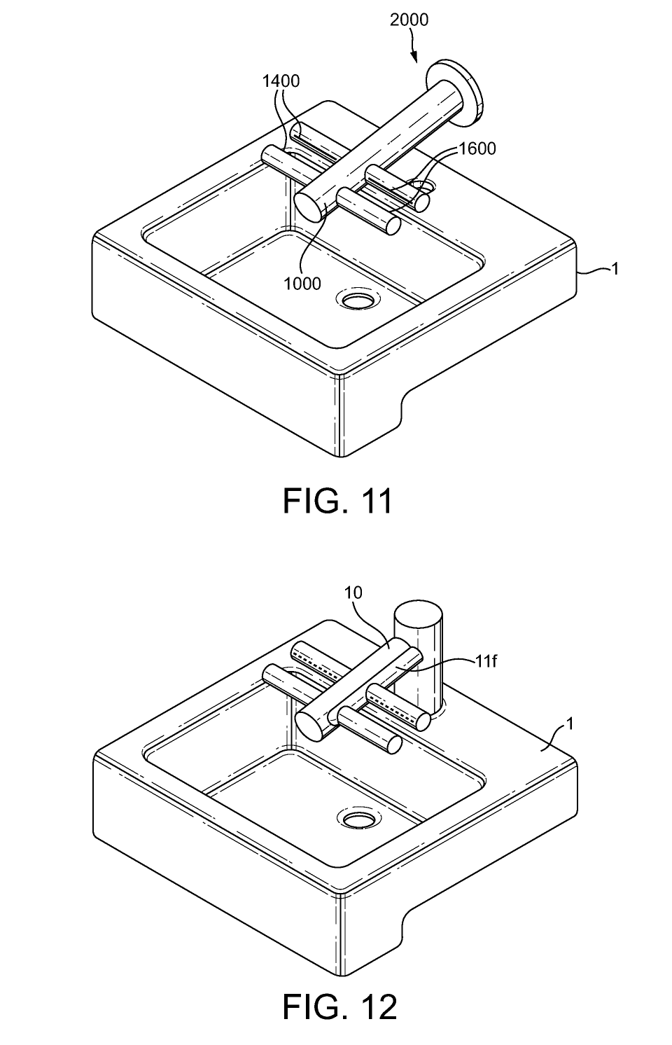

FIG. 11 shows a wall-mounted arrangement, in which a fixture 2000 is mounted to the wall behind the sink 1. The fixture 2000 is configured to provide “double-sided” drying, via an opposing pair of left-hand nozzles 1400: in this case a pair of elongate slits which in use span the width of a user's hand, and an opposing pair of right hand nozzles 1600: likewise taking the form of a pair of elongate slits.

The left-hand nozzles 1400 are provided on the left-hand side of the spout 1000, whereas the right-hand nozzles 1600 are provided on the right-hand side of the spout 1000. The spout 1000 thus acts as a central dividing partition between the nozzles 1400, 1600.

The fixture 2000 may be fitted to the wall using conventional wall fixings.

The main air supply duct for the nozzles does not have to run through the spout: for example, in the arrangement in FIG. 2, separate air ducts may instead be provided which run in side-by-side relation with the spout 10. This is illustrated in FIG. 12 (only one air duct, 11f, is visible). The spout 10 nevertheless acts as a dividing partition between the left-hand and right-hand nozzles.

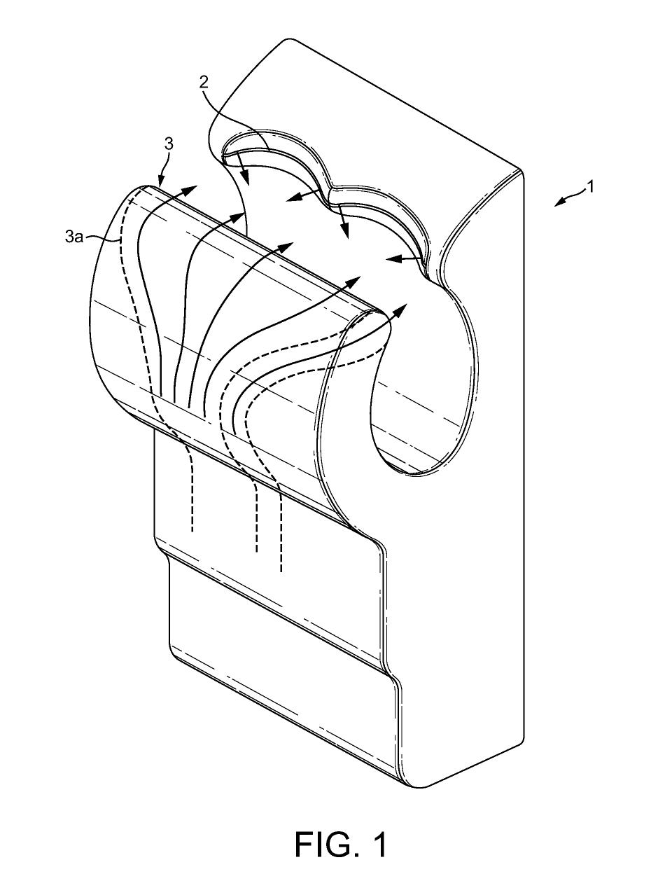

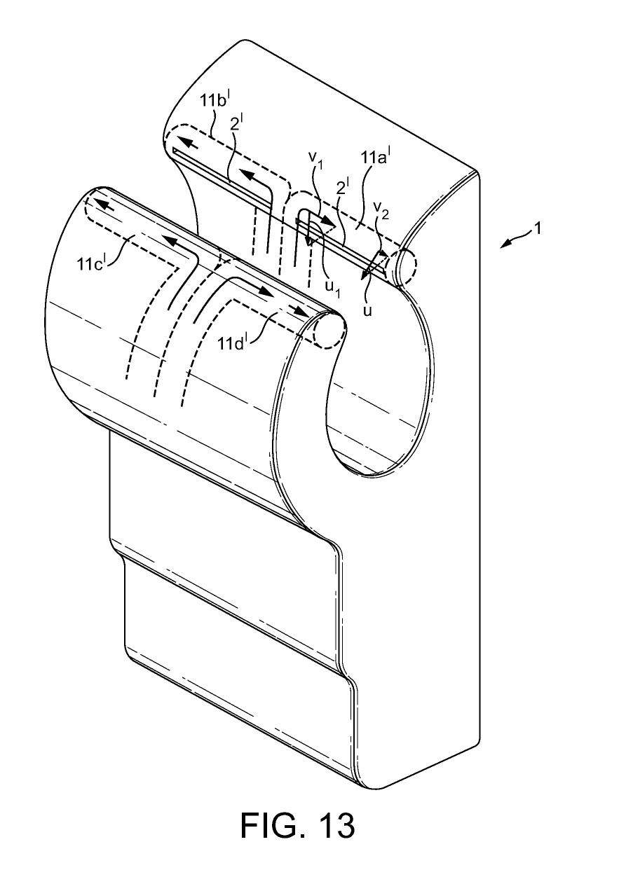

The hand dryer does not need to form part of a dual-purpose fixture for a sink. FIG. 13 shows a dedicated hand dryer 1′—similar in outline appearance to the hand dryer 1 shown in FIG. 1—in which the air is fed “inside-to-out” along four lateral supply ducts 11a′, 11b′, 11c′ and 11d′. Two rear slit-like nozzles 2′ are provided, one extending axially along each of the two supply ducts 11a′, 11b′. Similarly, two front slit-like nozzles are provided (not visible in FIG. 13) likewise extending axially along the supply ducts 11c′, 11d′. Both the rear nozzles and the front nozzles are straight.

Airflow is generated via a motor-driven fan (not shown) inside the hand dryer 1′. The airflow enters the inlet end of the supply ducts 11a′, 11b′, 11c′ and 11d′—being the end nearest the user's thumb and forefinger in use—and from here flows laterally outwardly, effectively feeding successive portions of the respective slit-like nozzle in series. Consequently, the exit velocity profile is similar to the profile shown in FIG. 8. Nearer the inlet end of the supply duct 11a′, for example, the axial duct velocity V₁ is high, and the resulting exit velocity U₁ has a significant axial component which helps angle the airflow into the user's thumb and forefinger. Away from the inlet end of the supply duct 11a′ the axial duct velocity V₂ falls away due to serial flow losses through the nozzle 2′, and the resulting exit velocity U₂ is consequently “straighter”.

1. A hand dryer comprising a plurality of hand dryer nozzles—one or more for each of a user's hands, the one or more left hand dryer nozzles being arranged to extend across the width of the user's left hand when it is held palm-open in front of the one or more left-hand nozzles, the one or more right-hand dryer nozzles being arranged to extend across the width of the user's right hand when it is held palm-open in front of the one or more right-hand nozzles, the one or more left-hand nozzles extending axially along the wall of a first air supply duct, the one or more right hand nozzles extending axially along the wall of a second air supply duct, each air supply duct communicating at its inlet end—being the end nearer the user's respective thumb in use—with a motor driven-fan for driving an axial airflow through duct.

2. The hand dryer according to claim 1, wherein the cross-sectional area of the supply duct is generally constant along the length of the supply duct, resulting in a progressive straightening of the nozzle exit velocity along the length of the supply duct, or else varies in a manner which nevertheless ensures such straightening of the nozzle exit velocity via a corresponding progressive reduction in the axial flow velocity through the supply duct.

3. The hand dryer according to claim 1, wherein the cross-sectional area of the duct tapers along the length of the supply duct.

4. The hand dryer according to claim 2, wherein the supply duct is substantially cylindrical.

5. The hand dryer according to claim 1, wherein the supply duct forms an external part of the hand dryer.

6. The hand dryer according to claim 1, comprising a motor-driven fan which is configured to force airflow through the nozzles at an exit speed which exceeds 100 m/s.
